(19) United States
(12) Patent Application Publication
(10) Pub. No.: US 2020/0246768 A1
(43) Pub. Date: Aug. 6, 2020

(54) BLENDING MODULE AND CONTROL METHODS

(71) Applicant: Ono Food Co., Oakland, CA (US)

(72) Inventors: Stephen Klein, Palo Alto, CA (US); Daniel Fukuba, Oakland, CA (US); Robert Moon, Oakland, CA (US)

(21) Appl. No.: 16/783,145

(22) Filed: Feb. 5, 2020

Related U.S. Application Data
(60) Provisional application No. 62/802,180, filed on Feb. 6, 2019.

(51) Int. Cl. B01F 13/00; A47J 43/07; A47J 43/046; A47J 31/60; B01F 15/00; G07F 17/00

(52) U.S. Cl. CPC B01F 13/0098; A47J 43/0716; A47J 43/046; B01F 2215/0014; B01F 15/00025; G07F 17/0064; A47J 31/60

(57) ABSTRACT

One variation of a method for blending food products includes: receiving a cup containing food products; locating a lip of the cup on a lower seat of a cup plate; rotating a blend plate about a pivot axis from a blend position to a closed position to locate an upper seat of the blend plate against the lip of the cup; driving the cup plate, about the pivot axis, toward the blend position; driving the blend plate against the cup plate to seal the upper seat against the lip of the cup; activating a blender blade of the blend plate to blend food products in the cup; driving the cup plate against the blend plate to seal the upper seat against the lip of the cup; driving the blend plate toward the closed position; rotating the blend plate toward the blend position; and delivering the cup.

### CROSS-REFERENCE TO RELATED APPLICATIONS

This Application claims the benefit of U.S. Provisional Application No. 62/802,180, filed on 6 Feb. 2019, which is incorporated in its entirety by this reference.

### TECHNICAL FIELD

This invention relates generally to the field of food production and more specifically to a new and useful blending module and control methods for automatic food processing in the field of food production.

### BRIEF DESCRIPTION OF THE FIGURES

FIG. 1 is a schematic representation of a blending module;

FIG. 2 is a schematic representation of the blending module;

FIG. 3 is a schematic representation of the blending module;

FIG. 4 is a schematic representation of the blending module;

FIG. 5 is a schematic representation of the blending module;

FIGS. 6A-6E are flowchart representations of a blending method; and

FIG. 7 is a flowchart representation of the blending method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

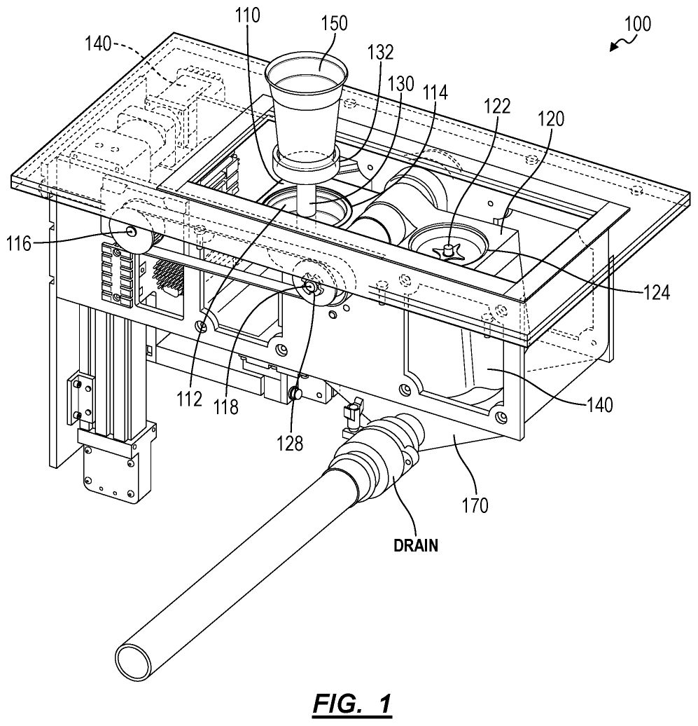

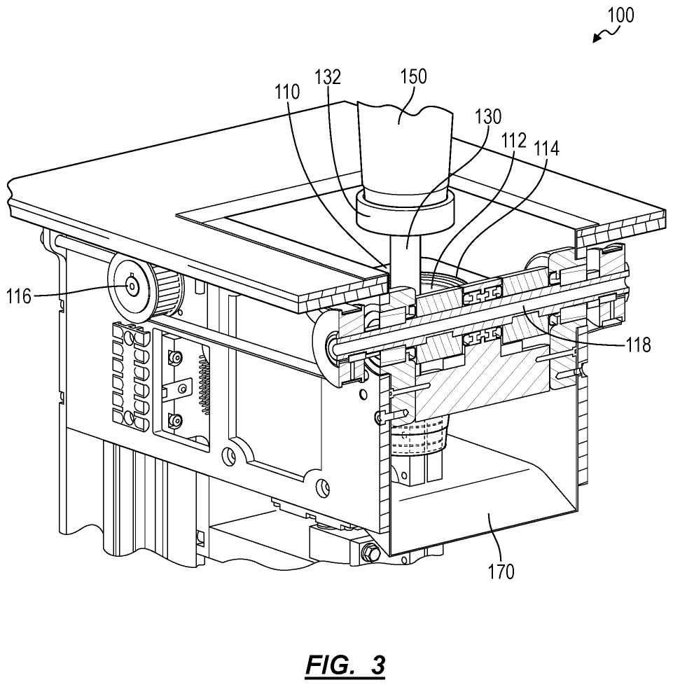

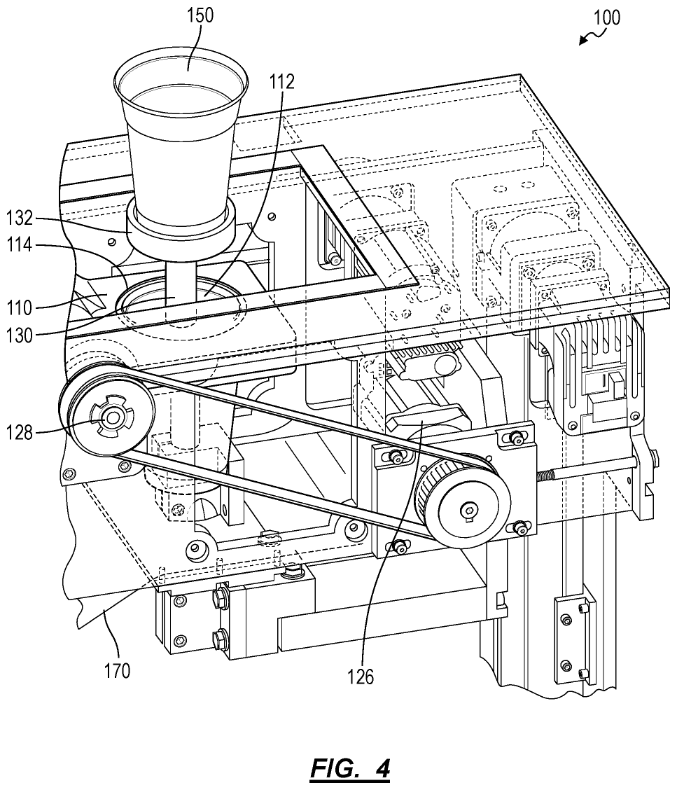

As shown in FIGS. 1-4, a blending module 100 for blending food products includes: a cup plate no configured to pivot about a pivot axis 180 between an upright position and a blend position, defining a cup bore 112 longitudinally offset from the pivot axis 180 and configured to receive a cup containing food products, and defining a lower seat 114 around the cup bore 112 and configured to support a lip 152 of the cup; a blend plate 120 configured to pivot about the pivot axis 180 between a closed position and the blend position, including a blender blade 122 that faces the cup bore 112 when the blend plate 120 and the cup plate 110 occupy the blend position, and defining an upper seat 124 around the blender blade 122 and configured to seal against the lip 152 of the cup; a cup elevator 130 approximately concentric with the cup bore 112 when the cup plate 110 occupies the upright position and operable in an extended position and a retracted position, the cup elevator 130 extending through the cup bore 112 to receive the cup in the extended position, and the cup elevator 130 dropped below the cup bore 112 to seat the lip 152 of the cup on the lower seat 114 of the cup plate 110 in the retracted position; a blender actuator 140 configured to rotate the blender blade 122; and a cup plate actuator 116 configured to drive the cup plate no from the upright position to the blend position. The blending module 100 also includes a blend plate actuator 126 configured: to drive the blend plate 120 from the blend position to the closed position in response to the cup elevator 130 seating the lip 152 of the cup on the lower seat 114 of the cup plate 110; and to apply a target clamping torque to the blend plate 120 against the cup plate actuator 116 driving the cup plate no toward the blend position, the target clamping torque corresponding to a target clamping force between the upper seat 124 of the blend plate 120 and the lip 152 of the cup to prevent fluid leakage out of the cup and past the upper seat 124 when the cup is inverted during the blend cycle.

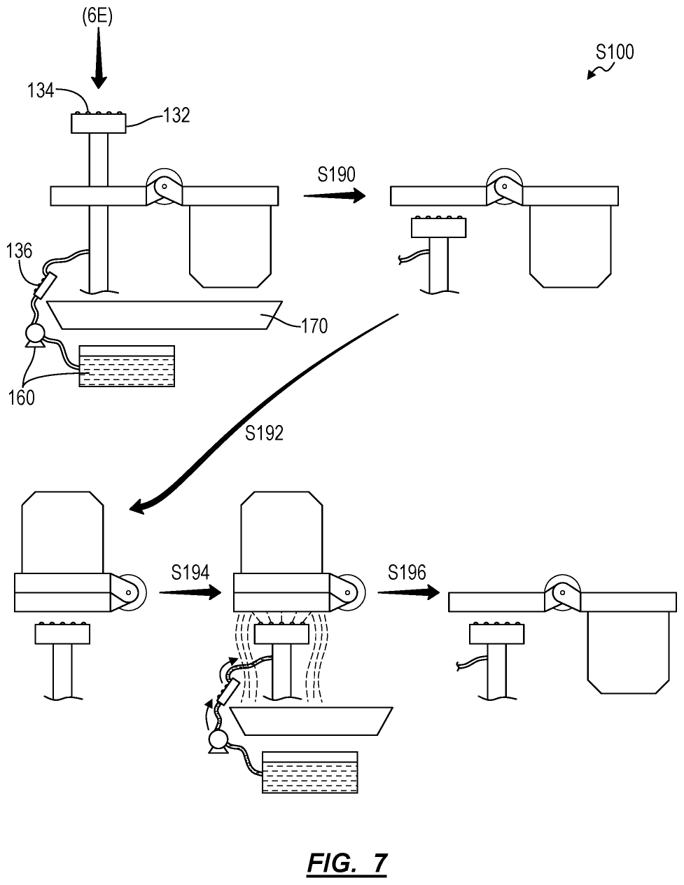

In one variation, as shown in FIG. 7, the blending module 100 includes the cup elevator 130 defining: a cup platform 132 configured to receive and support a base of the cup and inset from an internal wall of the cup bore; a set of nozzles 134 arranged on the cup platform 132 facing the blender blade 122 when the blend plate 120 occupies the closed position and configured to spray the blender blade 122 and the blend plate 120 with cleaning fluid in the closed position during a cleaning cycle; and a manifold 136 configured to fluidly couple the set of nozzles to a cleaning fluid inlet. The blending module 100 further includes a cleaning fluid supply 160 fluidly coupled to the manifold 136, the cleaning fluid supply 160 including: a reservoir configured to hold cleaning fluid; and a pump fluidly coupled to the manifold 136 and configured to displace cleaning fluid from the reservoir, into the manifold 136, and through the set of nozzles 134.

### 2. Method

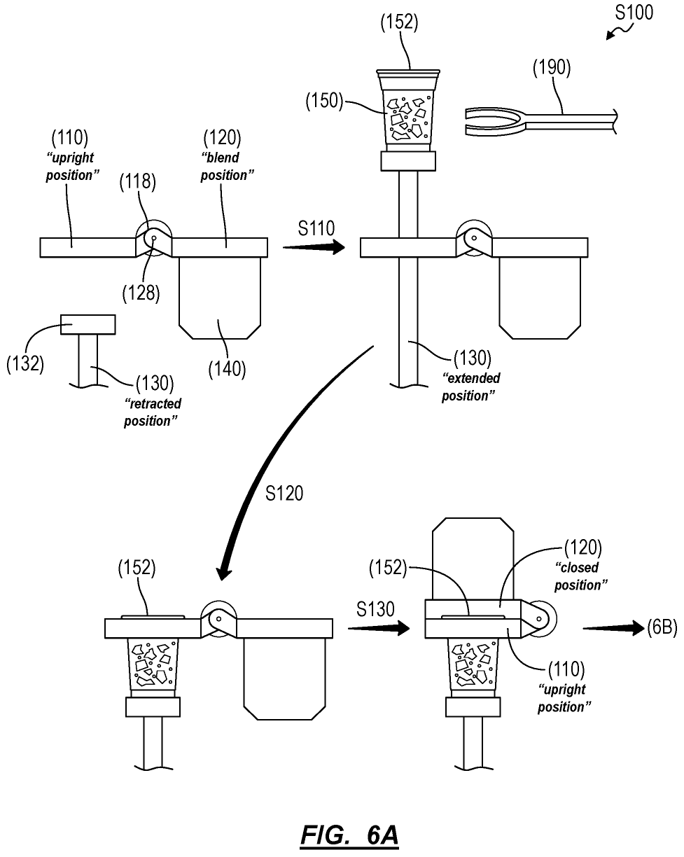

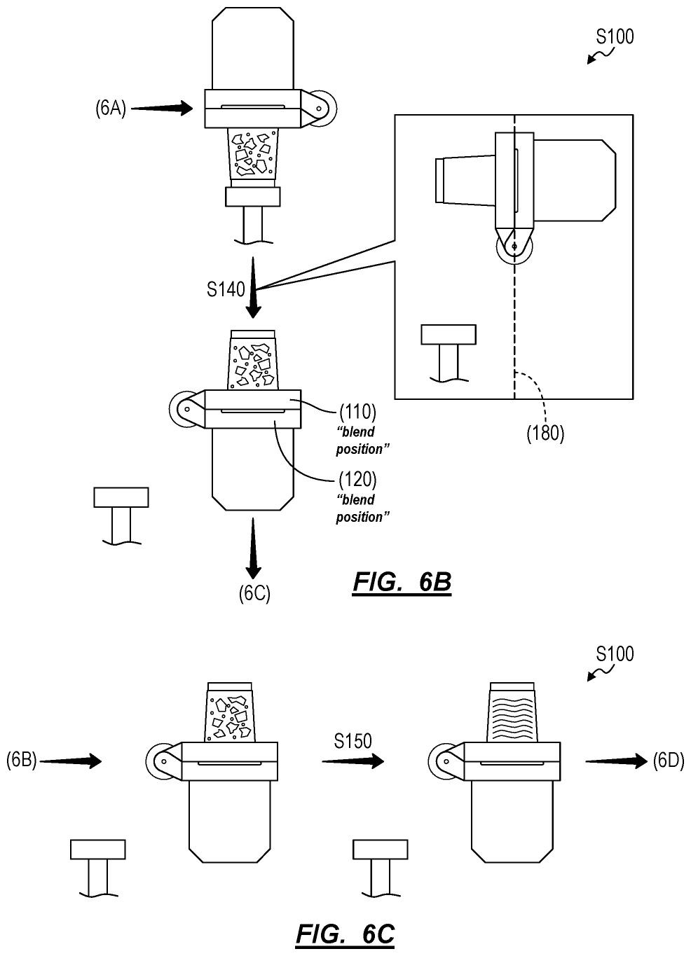

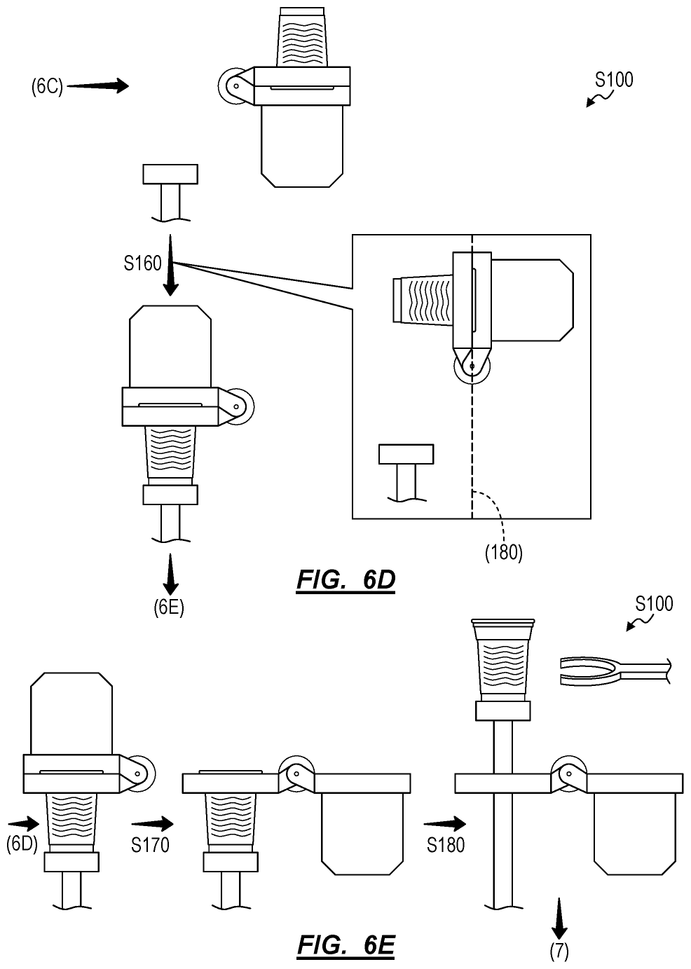

As shown in FIGS. 6A-6E, a method S100 for blending food products includes, during a blend cycle: raising a cup platform 132 from a retracted position, through a cup bore 112 in a cup plate 110 occupying an upright position, to an extended position above the cup plate 110 to receive a cup containing food products in Block Silo; lowering the cup platform 132 from the extended position, through the cup bore 112, to the retracted position to locate a lip 152 of the cup on a lower seat 114 of the cup plate 110 in Block S120, the cup bore 112 longitudinally offset from the pivot axis 180 and encircled by the lower seat 14; rotating a blend plate 120 about the pivot axis 180 from a blend position to a closed position to locate an upper seat 124 in the blend plate 120 against the lip 152 of the cup in Block S130, the blend plate 120 comprising a blender blade 122, the blender blade 122 encircled by the upper seat 124 and facing the cup bore 112 when the blend plate 120 and the cup plate 110 occupy the blend position; during a first transition period, driving the cup plate 110, about the pivot axis 180, toward the blend position and driving the blend plate 120 against the cup plate 110 to seal the lower seat 114 of the cup plate 110 and the upper seat 124 of the blend plate 120 against the lip 152 of the cup in Block S140; during a blend period succeeding the first transition period, activating the blender blade 122 to blend food products in the cup to form an emulsion in Block S150; during a second transition period succeeding the blend period, driving the blend plate 120, about the pivot axis 180, toward the closed position and driving the cup plate 110 against the blend plate 120 to seal the lower seat 114 of the cup plate 110 and the upper seat 124 of the blend plate 120 against the lip 152 of the cup in Block S160; following the second transition period, rotating the blend plate 120 about the pivot axis 180 toward the blend position in Block S170; and raising the cup platform 132 from the retracted position to the extended position to lift the cup out of the cup bore 112 and to deliver the cup in Block S180.

In one variation shown in FIG. 7, the method S100 further includes, during a cleaning cycle succeeding the blend cycle: lowering the cup platform 132 from the extended position toward the retracted position in Block S190; and rotating the blend plate 120 about the pivot axis 180 from the blend position to the closed position to locate the blender blade 122 of the blend plate 120 offset above the cup platform 132 in Block S192. In this variation, the method S100 further includes: during a cleaning period, dispensing cleaning fluid through a set of nozzles 134 in the cup platform 132 and facing the blender blade 122 and activating the blender blade 122 to rinse surfaces of the blender blade 122 with cleaning fluid in Block S194; and rotating the blend plate 120, about the pivot axis 180, from the closed position toward the blend position in Block S196.

### 3. Applications

Generally, the blending module 100 functions as a standalone system for receiving a cup containing unblended foodstuffs, blending contents of the cup into an emulsion, and returning the cup and emulsion. For example, the blending module 100 can be installed at the end of a series of food and liquid dispensers in a modular food assembly kiosk. In this example, these solid and liquid food dispensers can sequentially load cups—moving along a conveyor—with frozen fruits, refrigerated vegetables, yogurt, ice, and fruit juice according to orders submitted by patrons, and the modular food assembly kiosk can then sequentially load these cups on the cup elevator 130 in the blending module 100. The blending module 100 can then: automatically blend contents of the cups into an emulsion; return the cups—with its blended emulsions—directly to its patron or to a next module in the modular food assembly kiosk for further processing (e.g., dispensation of whipped cream, installation of lids); and then automatically execute a cleaning cycle to clear food remnants from surfaces in the blending module 100 that contacted food during this last blend cycle before receiving a next cup from the line of solid and liquid food dispensers.

In particular, upon receipt of a cup loaded with solid and liquid food products, the blending module 100 can: lower the cup elevator 130 from the extended position to the retracted position, thereby locating the cup in the cup bore 112 of the cup plate 110—initially in the upright position—and seating a lip 152 of the cup on the lower seat 114 surrounding the cup bore 112; trigger the blend plate actuator 126 to rotate the blend plate 120 from the blend position into the closed position, thereby engaging the upper seat 124 of the blend plate 120 around the lip 152 of the cup; and then trigger the cup plate actuator 116 to drive the cup plate 110 (and the blend plate 120 and the cup) toward the blend position while the blend plate actuator 126 applies a torque to the blend plate 120 opposite the direction of motion of the cup plate 110, thereby forcing the blend plate 120 against the cup lip 152 and the lower seat 114 of the cup plate no and thus sealing the lip 152 of the cup against the upper seat 124 to prevent leakage from the cup as the cup is inverted. Therefore, the blending module 100 can servo the output of the cup plate actuator 116 to the angular position of the cup plate no and servo the output of the blend plate actuator 126 to torque applied to the blend plate 120 (and therefore to a compressive force applied by the upper seat 124 of the blend plate 120 across the lip 152 of the cup). Once the cup plate 110 and the blend plate 120 enter the blend position, the blending module 100 can activate the blender actuator 140 to rotate the blender blade 122—now immersed in the contents of the inverted cup—to blend the contents of the cup into an emulsion. During this blend period, the cup plate actuator 116 can continue to apply a torque to the cup plate 110 to drive the cup plate 110 and blend plate 120 against a stop at the blend position, thereby continuing to compress the lip 152 of the cup against the upper seat 124 of the blend plate 120 and thus continuing to prevent leakage from the cup despite increased pressure and/or agitation inside the cup while the blender actuator 140 is active. (Alternatively, the cup plate actuator 116 can define and implement virtual hard stops by holding the cup plate 110 at target radial positions throughout the blend cycle.)

The blending module 100 can implement different blending techniques to blend contents of the cup into an emulsion based on contents of the cup. For example, the blending module 100 can alter characteristics of the blend period including: duration of actuating the blender actuator 140; rotational speed of the blender blade 122; frequency of pulsing of the blender actuator 140; and viscosity of final product, etc.

Once the contents of the cup are fully blended, the blending module 100 can reverse the foregoing process to return the cup plate 110 and the blend plate 120 to the upright and closed positions, respectively, including servoing the output of the blend plate actuator 126 to the angular position of the blend plate 120 and servoing the output of the cup plate actuator 116 to torque applied to the cup plate 110 (and therefore to a compressive force applied by the upper seat 124 of the blend plate 120 across the lip 152 of the cup) in order to prevent leakage from the cup as the cup is returned to its upright orientation. The blending module 100 can then: trigger the blend plate actuator 126 to drive the blend plate 120 back to the blend position; and trigger the cup elevator 130 to raise the cup out of the cup bore 112 in the cup plate 110, such as for manual retrieval by a patron or operator or for automated retrieval by a transfer subsystem 190 (e.g., a conveyor, robotic arm).

Additionally, the blending module 100 can execute a cleaning cycle to clean food remnants from the cup plate no and the blend plate 120 once the cup—with its emulsified contents—is retrieved from the cup elevator 130. For example, the cup elevator 130 can include a set of nozzles 134 facing upward. At the conclusion of this blend cycle, the blending module 100 can: trigger the blend plate actuator 126 to return the blend plate 120 to the closed position; trigger a pump or other cleaning subsystem to pump a cleaning fluid (e.g., water, steam) through nozzles in the cup elevator 130 to wash or rinse the blender blade 122 and the blend plate 120 (e.g., as the blender actuator 140 is pulsed); and then trigger the blend plate actuator 126 to return the blend plate 120 to the blend position in preparation for receiving and processing a next cup. Furthermore, the blending module 100 can execute a sanitizing cycle to sanitize surfaces of the blending module 100 contacting food products or surfaces adjacent to the cup plate 110, the blend plate 120, and/or the cup containing food products.

### 4. Cup Plate

Generally, the cup plate 110 is configured to pivot about a pivot axis 180 between an upright position and a blend position, defines a cup bore 112 longitudinally offset from the pivot axis 180 and configured to receive a cup containing food products, and defines a lower seat 114 around the cup bore 112 and configured to support a lip 152 of the cup.

In one implementation shown in FIGS. 1-4, the cup plate 110: defines a circular cup bore 112 of diameter between the maximal and minimal diameters of a lip 152 of a known cup geometry; and defines a lower seat 114 of a diameter (slightly) greater than the diameter of the lip 152 of a cup—of this known cup geometry—and configured to receive and retain the underside of the lip 152 of this cup with the base of the cup extending below the cup plate 110. For example, the cup plate 110 can include an aluminum or steel plate, and the lower seat 114 can include a rigid aluminum or steel ring extending above a nominal upper face of the cup plate no to engage the underside of the lip 152 of a cup. In this example, a corner between the lower seat 114 and the nominal upper face of the cup plate 110 can be filleted (or “radiused”) to prevent collection of food remnants in this corner; the nominal upper face of the cup plate 110 can also be perforated or otherwise include drain ports to enable fluid collecting on the cup plate 110 to drain downward (e.g., into a basin 170, as described below).

The cup plate no is also coupled to a cup plate axle 118 extending laterally across the blending module 100 and coaxial with a pivot axis 180 such that the cup bore 112 is longitudinally offset from the cup plate axle 118. The cup plate 110 can therefore pivot about the pivot axis 180 between two (extreme) positions, including an upright position and a blend position (e.g., offset 180° from the upright position). In the upright position, the cup bore 112 of the cup plate 110 is approximately coaxial with the cup elevator 130 (described below); when occupying the upright position at the beginning of a blend cycle, the cup plate 110 can thus receive a cup lowered into the cup bore 112 by the cup elevator 130, as described below. In the blend position, the cup plate 110 is driven against the blend plate 120 with a cup (substantially) inverted and sealed against the upper seat 124 of the blend plate 120 to prevent leakage from the cup as the blender blade 122 blends contents of the cup; in particular, in the blend position, the cup plate 110 is driven toward the blend plate 120 to compress the lip 152 of a cup between the lower seat 114 of the cup plate no and the upper seat 124 of the blend plate 120 to seal the lip 152 of the cup to the blend plate 120.

The blending module 100 can also define a cup plate 110 stop located at the upright position and configured to support the cup plate no against further rotation past the upright position, such as when the blend plate actuator 126 drives the blend plate 120 toward the closed position at the beginning of a blend cycle as described below.

### 5. Cup Elevator

The cup elevator 130 is approximately (e.g., within five millimeters) concentric with the cup bore 112 when the cup plate 110 occupies the upright position and is operable in an extended position and a retracted position. In the extended position, the cup elevator 130 extends through the cup bore 112 of the cup plate no to receive a next cup; in the retracted position, the cup elevator 130 drops below the cup bore 112 to enable the lip 152 of the cup to engage the lower seat 114 of the cup plate 110.

In one implementation, the cup elevator 130 includes: a linear slide (e.g., a linear actuator) defining an extensible axis approximately parallel to the cup bore 112 when the cup plate 110 occupies the upright position; and a cup platform 132 coupled to a distal end of the linear slide configured to receive and support the base of a cup, and approximately concentric with the cup bore 112 when the cup plate 110 occupies the upright position. For example, the cup platform 132 can define a shallow tapered bore configured to accept, support, and center the base of a cup when the cup is first loaded into the blending module 100. The cup platform 132 can also include a set of vacuum ports fluidly coupled to a vacuum pump (or vacuum reservoir); when a cup is loaded onto the cup platform 132 (e.g., by a cup conveyor), the blending module 100 can actuate the vacuum pump (or open a valve to the vacuum reservoir) in order to draw a vacuum across the face of the cup platform 132 and thus retain the base of the cup on the cup platform 132 until the cup engages the lower seat 114 when the cup elevator 130 is lowered into the retracted position.

Therefore, in the raised position, the cup platform 132 is elevated above the cup plate 110—occupying the upright position—to receive a cup at the beginning of a blend cycle and to release the cup at the end of the blend cycle. In the retracted position, the cup platform 132 is lowered below the cup plate no such that the lip 152 of the cup—recently loaded onto the cup platform 132—can engage the lower seat 114 of the cup plate 110. Furthermore, in the retracted position, the top surface of the cup platform 132 can be offset below the bottom surface of the cup by 5 millimeters in order to: enable the cup to seat fully in the cup bore 112; limit opportunity for interference between the cup and the cup platform 132 when the blend plate 120 is subsequently driven into the closed position; and enable the cup plate no and the blend plate 120 to pivot collectively toward the blend position without binding against the cup elevator 130.

### 6. Blend Plate

The blend plate 120 is configured to pivot about the pivot axis 180 between a closed position and the blend position, includes a blender blade 122 that faces the mouth of the cup occupying the cup bore 112 when the blend plate 120 and the cup plate 110 occupy the blend position, and defines an upper seat 124 around the blender blade 122 and configured to seal against the lip 152 of the cup.

In one implementation, the blend plate 120: defines a rigid platform including a first side configured to face the cup plate 110 and a second side opposite the first side; and includes a blender blade 122 pivotably coupled to the rigid platform, extending outwardly from the first side of the blend plate 120, and sealed against the rigid platform, such as with a sealed thrust bearing or taper bearing and seal. In one example, the blender blade 122 is mounted to a driveshaft that runs in a set of radial bearings, and a lip seal forms a seal between the blend plate 120 and the driveshaft. In this implementation, the blend plate 120 also defines an upper seat 124 approximately concentric with the rotational axis of the blender blade 122 and configured to seal against the top of a lip 152 of a cup when the blend plate 120 is driven against the cup plate 110 (e.g., in both the closed and blend positions). The blend plate 120 can further include an elastomeric seal (e.g., an O-ring) arranged across the upper seat 124 and configured to mate with and seal against the top side of the lip 152 of a cup. (Additionally or alternatively, the cup plate 110 can include an elastomeric seal arranged across the lower seat 114.)

In one implementation shown in FIG. 1, the first side of the blend plate 120 defines a well (e.g., a hemispherical or ogive-shaped cavity, a concave section) inset from the upper seat 124 and extending toward the second side of the blend plate 120. In this implementation, the blender blade 122 is arranged inside the well such that none or a limited section of the blender blade 122 extends beyond the first side of the blend plate 120. Thus, when the cup plate 110 and the blend plate 120 are transition into the blend position to invert a cup, contents of the cup can flow into the well to immerse the blender blade 122; when then blender actuator 140 is concurrently activated, the blender blade 122 can sling these contents toward the rigid face of the well rather than toward the interface between the upper seat 124 and the lid of the cup, thereby reducing peak local pressure near thus interface, reducing opportunity for leakage past this interface, and/or reducing a minimum torque—applied to the cup and blend plate axle 128—necessary to prevent leaks past this interface during this blend cycle. In particular, in this implementation, the blender blade 122 can be set within the well defined by the blend plate 120, and the well can shield the interface between the upper seat 124 and the lid of the cup from contents slung by the blender blade 122—inside the volume between the cup and the well—during the blend cycle. Furthermore, the well can form a relatively large enclosed volume between the cup and the blend plate 120, thereby: enabling contents in the cup to flow more freely around the blender blade 122 during the blend cycle and thus yield greater consistency in the resulting emulsion; and yielding a lower maximum pressure in the cup when the blender blade 122 is actuated during blend cycle and thus reducing deformation (e.g., folding or bending) and possibility of failure of the cup (e.g., a thin-walled “single use” cup).

The blend plate 120 is also coupled to a blend plate axle 128 extending laterally across the blending module 100 and coaxial with the cup plate axle 118 such that the upper seat 124, lower seat 114, cup bore 112, and blender blade 122 are approximately concentric when the cup plate 110 and the blend plate 120 occupy the blend position. The blend plate 120 can therefore pivot about the pivot axis 180 between two (extreme) positions, including the blend position and a closed position (e.g., offset 180° from the blend position). In the closed position, the blend plate 120 is pivoted about the pivot axis 180 toward the cup plate 110—concurrently occupying the upright position—such that the upper seat 124 of the blend plate 120 engages and seals against the lip 152 of a cup occupying the cup bore 112 in the cup plate 110. In the blend position, the blend plate 120: is separated from (e.g., approximately 180° opposed from) the cup plate 110 when the cup plate 110 occupies the upright position; and is clamped against the cup plate no with the cup inverted and sealed against the upper seat 124 of the blend plate 120 when the cup plate 110 is also in the blend position.

The blending module 100 can also define a blend plate stop located at the blend position and configured to support the cup plate 110 against further rotation past the blend position, such as when the cup plate actuator 116 drives the cup plate 110 toward the blend position at the beginning of a blend cycle as described below. Additionally, the blend plate stop can define a home or (“zero”) position of the cup plate 110 and the blend plate 120. For example, the blending module 100 can calibrate positions of the cup plate actuator 116 and the blend plate actuator 126 at the start of each blend cycle by driving the cup plate no and the blend plate 120 against the blend plate stop and store these final angular positions of the cup plate actuator 116 and the blend plate actuator 126 as “zero” positions of the cup plate 110 and the blend plate 120, respectively.

### 7. Blender Actuator

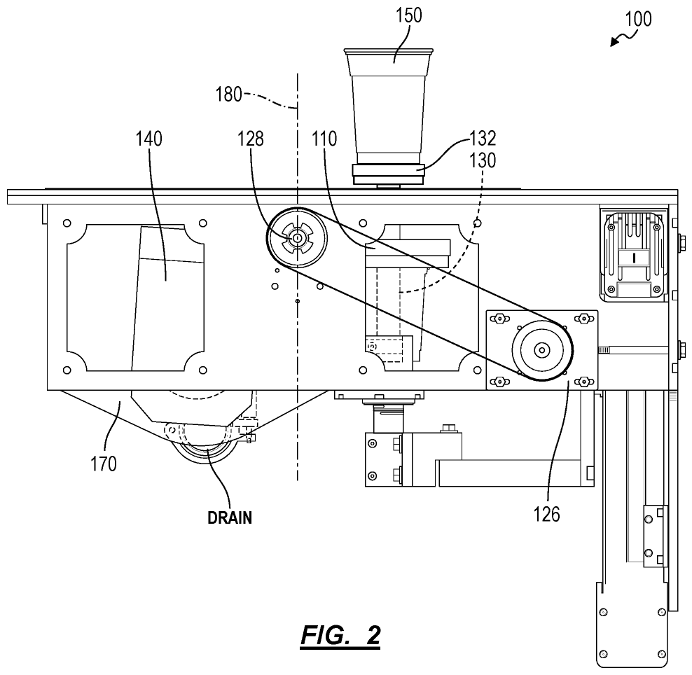

The blending module 100 also includes a blender actuator 140 configured to rotate the blender blade 122. In one implementation shown in FIGS. 1 and 2, the blender actuator 140 is mounted to the second side of the blend plate 120 opposite the blender blade 122 and is fixedly coupled to the blender blade 122, such as with a flexible or splined coupling passing through the blend plate 120. In this implementation, the blending module 100 can activate the blender actuator 140 to blend contents of a cup when the cup plate 110 and the blend plate 120 occupy the blend position during a blend cycle and activate the blender actuator 140 when the cup plate no and the blend plate 120 occupy the upright/closed position during a cleaning cycle. In this implementation, the blender actuator 140—fixedly coupled to the blender blade 122—is configured to rotate about the pivot axis 180 as the blend plate 120 rotates between the blend position and the closed position during blend and cleaning cycles. Additionally, the blender actuator 140 is sealed such that food products and waste do not contact surfaces of the blender actuator 140, thus preventing wear and tear on the blender actuator 140 from food products (e.g., solid and liquid food products) as well as cleaning products (e.g., water, steam, chemicals) used during cleaning cycles.

In the foregoing implementation, the blend plate axle 128 can define a hollow pivot shaft, and the blender actuator 140 can be electrically coupled to a power bus in the blending module 100 via electrical wiring (e.g., a flexible power cable) routed through the blend plate axle 128 such that electrical connections to the blender actuator 140 remain isolated from solid and liquid food waste that may spill out of the cup or off of the blade plate during a blend cycle.

In another implementation, the blender actuator 140 is fixedly mounted in the blending module 100. In this implementation, the blender blade 122 is coupled to a driveshaft (e.g., a male-splined driveshaft end) extending outwardly from the second side of the blend plate 120; and the blender actuator 140 includes a driveshaft coupler (e.g., a female-splined coupler) configured to engage this driveshaft when the blend plate 120 occupies the blend position. Therefore, in this implementation, the blending module 100 can selectively activate the blender actuator 140 when the cup plate 110 and the blend plate 120 occupy the blend position.

In one variation, the blending module 100 is further configured to cool the blender actuator 140 and/or the blender blade 122 in order to limit heating of a cup and its contents during a blend cycle. In particular, over multiple consecutive blend cycles, the blender actuator 140 can warm, and the driveshaft and the blender blade 122 can transfer heat from the blender actuator 140 into contents of a cup, thereby warming and reducing viscosity of the resulting emulsion in this cup. Therefore, in one example: the driveshaft in the blender actuator 140 includes a coolant channel and is fluidly coupled to a coolant reservoir containing coolant (e.g., water, alcohol); and the blend module 100 includes a temperature sensor arranged in the blend plate 120 or coupled to the blender actuator 140. Additionally or alternatively, the blend module 100 can include a heat exchanger (e.g., an evaporator coil) arranged about the blender actuator 140 and fluidly coupled to the coolant condenser. Yet alternatively, the blend plate 120 can include an internal coolant channel coupled to the coolant reservoir. In this example, the controller can: monitor the temperature of the blade plate and/or the blender actuator 140 based on outputs of the temperature sensor; and implement closed-loop controls to selectively actuate a coolant pump to pump coolant from the coolant reservoir through the driveshaft of the blender actuator 140, around the blender actuator 140, and/or through the blend plate 120 in order to maintain the temperatures of these masses (e.g., near or below room temperature).

Therefore, the blending module 100 can actively cool the driveshaft, the blender actuator 140 and/or the blend plate 120 in order to: prevent overheating of the blend plate 120 over multiple consecutive blend cycles; and limit heat transfer from the blend plate 120 and the blender blade 122 into food products in a cup during a blend cycle.

### 8. Plate Actuators

The cup plate actuator 116 is configured to drive the cup plate 110 from the upright position to the blend position. In one implementation, the cup plate actuator 116 includes a servo motor, gearhead motor, stepper motor, or other electromechanical actuator coupled to the cup plate axle 118s, such as via a timing belt or gear train. The cup plate actuator 116 can thus apply torque to the cup plate axle 118 to drive the cup plate 110—about the pivot axis 180—from the upright position toward the blend position. Furthermore, the cup plate actuator 116 can apply a target clamping torque to the cup plate 110—against the blend plate actuator 126—in order to achieve a target clamping force between the upper seat 124 of the blend plate 120 and the lip 152 of the cup to prevent fluid leakage from the cup as the blend plate actuator 126 drives the cup plate no from the blend position toward the closed position,

The blending module 100 can also include a cup plate 110 position sensor (e.g., a rotary encoder) coupled to an output shaft of the cup plate actuator 116 or to the cup plate axle 118 directly and configured to output a signal corresponding to an absolute angular position or relative change in angular position of the cup plate 110. The blending module 100 can also include a cup plate 110 torque sensor coupled to the cup plate axle 118 and configured to output a signal corresponding to a torque applied by the cup plate actuator 116 to the cup plate axle 118. Alternatively, the blending module 100 (or modular food assembly kiosk, or other system) can monitor a current draw and/or back-EMF of the cup plate actuator 116 during operation and translate these values into measures of torque output by the cup plate actuator 116 and/or torque applied to the cup plate axle 118.

Similarly, the blend plate actuator 126 is configured: to drive the blend plate 120 from the blend position to the closed position in response to the cup elevator 130 seating the lip 152 of the cup on the lower seat 114 of the cup plate 110; and to apply a target clamping torque to the blend plate 120 against the cup plate actuator 116 driving the cup plate 110 toward the blend position. Generally, like the cup plate actuator 116, the blend plate actuator 126 can be coupled to the blend plate axle 128, and the blending module 100 can include a blend plate position sensor, can include a blend plate 120 torque, and/or can monitor torque output of the blend plate actuator 126 based on current draw or back-EMF of the blend plate actuator 126.

For example, the blend plate actuator 126 can apply a first torque to the blend plate 120 (slightly) less than and opposite a torque applied to the cup plate 110 by the cup plate actuator 116 as the cup plate actuator 116 transitions the cup plate 110 from the upright position into the blend position in order to achieve a first clamping force between the cup plate 110 and blade plate 120, thereby sealing the lid of the cup against the upper seat 124 to prevent liquid from leaking out of the cup between the lid and the upper seat 124. Similarly, once the blend plate 120 engages a stop in the blend position, the cup plate actuator 116 can apply a second torque—greater than the first torque—to the cup plate 110 while the blender actuator 140 is active in order to achieve a second, greater clamping force between the cup plate 110 and the blade plate 120, thereby sealing the lid of the cup against the upper seat 124 to prevent liquid from leaking out of the cup between the lid and the upper seat 124 under greater internal pressures inside the cup while the blender blade 122 rotates inside the cup.

Therefore, the cup plate actuator 116 and the blade plate actuator 126 can cooperate to seal the lip 152 of the cup against the upper seat 124 throughout a blend cycle without necessitating a secondary clamp or lock between the cup plate 110 and the blade plate 120, thereby reducing a quantity of components in the blender module 100 and reducing quantities of surfaces and inside corners in which food material can collect during operation.

### 9. Conveyance and Cup Loading

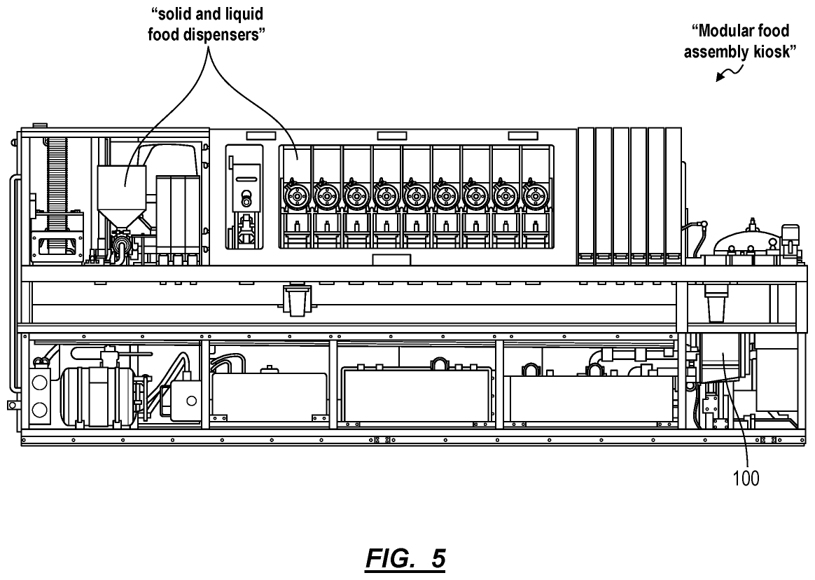

In one implementation shown in FIG. 5, the blending module 100 is installed in a modular food assembly kiosk that includes a linear conveyor configured to sequentially move cups along a series of food modules that selectively dispense solid and liquid food products into these cups, such as according to custom food orders entered by patrons. A first transfer subsystem—such as a robotic arm or a rotating boom interposed between a last food module and the blending module 100—retrieves cups from the end of the linear conveyor and sequentially loads these cups on the cup platform 132. In this implementation, the module food assembly kiosk can also include a second transfer subsystem—such as a second robotic arm or a second rotating boom interposed between the blending module 100 and a delivery window—that retrieves cups from the cup platform 132 and sequentially delivers these cups to a delivery window for retrieval by patrons. For example, the blending module 100 can: raise the cup elevator 130 to receive a cup from a set of food dispensers (e.g., via a first transfer subsystem) configured to load the cup with food products; and, after blending, raise the cup elevator 130 to deliver the cup (e.g., via a second transfer subsystem) to a particular patron associated with an order for the cup.

In one variation, as shown in FIGS. 6A and 7, the blending module 100 includes or interfaces with a transfer subsystem 190 (e.g., a robotic arm) configured to selectively load cups onto the cup elevator 130 and to retrieve these cups from the cup elevator 130 at the end of a blend cycle. For example, the blending module 100 can interface with a robotic arm defining a gripper configured to grip, move, and release cups. In this example, the blending module 100 can: raise the cup elevator 130 from the retracted position toward the extended position to receive a cup located vertically above the cup platform 132 of the cup elevator 130—by the robotic arm—with a base of the cup located at a first position. The blending module 100 can then trigger the cup elevator 130 to raise the cup platform 132 to the extended position—offset above the first position (e.g., by five millimeters)—such that the cup platform 132 lifts the cup upward once fully extended. Once the cup is lifted by and thus seated onto the cup platform, the blending module 100 can interface with the transfer subsystem 190 to release (e.g., open) the gripper and trigger the cup elevator 130 to retract toward the retracted position, thereby lowering the cup into the cup bore 112 with a lip 152 of the cup resting on the lower seat 114 of the cup plate 110.

In one variation, the blending module 100 includes a cup position sensor configured to detect a position of the cup on the cup platform 132 and/or in the cup bore 112. For example, the cup position sensor can include an optical depth sensor defining a field of view extending laterally over the cup platform 132 and configured to output a signal corresponding to a distance to a side of the cup when perched on the cup elevator 130 and when seated in the cup bore 112. In this example, the controller can verify the position of the cup on the cup elevator 130 or in the cup bore 112 if the detected distance falls within a target range corresponding to proper cup location. Thus, in this variation, the blending module 100 can monitor the position of the cup during transfers (or “handoffs”) of the cup between the cup elevator 130 and the transfer subsystem 190 in order to detect cup position errors prior to executing a next step of the blend cycle.

In one variation, the blending module 100 includes a set of cup position sensors configured to detect a position of the cup on the cup platform 132 after receiving the cup and/or when lowering the cup into the cup bore 112. For example, the blending module 100 can: raise the cup platform 132 to receive a cup; lower the cup platform 132 toward the retracted position; and, before seating the lip 152 of the cup on the lower seat 114 of the cup plate 110, access an x-distance sensor value from an x-axis distance sensor and a y-distance sensor value from a y-axis distance sensor. Then, in response to the x-distance sensor value, the y-distance sensor value, or both the x-distance and y-distance sensor values falling outside of a target range, the blending module 100 can: raise the cup platform 132; trigger the transfer subsystem 190 to remove the cup from the cup platform 132 and return the cup to the cup platform 132 (e.g., to adjust the cup placement); and repeat this process until both the x-distance and y-distance sensor values fall within the target range. Thus, in this variation, the blending module 100 can monitor the position of the cup on the platform 132 to detect alignment errors during placement of the cup onto the cup platform 132 prior to executing a next step of the blend cycle.

However, the blending module 100 can include or interface with a transfer subsystem 190 of any other type and operable in any other way to transfer cups onto and/or off of the cup elevator 130.

### 10. Blending Process

During operation, the blending module 100 can execute blend cycles—such as controlled internally by a controller in the blending module 100 or by a controller in the modular food assembly kiosk or other connected system—to blend contents of cups into emulsions.

In one implementation, upon conclusion of a blend cycle (or a clean cycle) and in preparation for executing a next blend cycle, the blending module 100 (or the modular food assembly kiosk or other connected system): triggers the cup plate actuator 116 to drive the cup plate 11o to the upright position; triggers the blend plate actuator 126 to drive the blend plate 120 to the blend position; and triggers the cup elevator 130 to rise to the extended position to receive a next cup. As shown in FIG. 6A, once the transfer subsystem 190 loads a cup—containing solid and/or food liquid contents—onto the cup platform 132, the blending module 100 triggers the cup elevator 130 to lower the cup platform 132 to the retracted position, thereby enabling the cup to enter the cup bore 112 and the underside of the lip 152 of the cup to loosely engage the lower seat 114 on the cup plate 110. The blending module 100 then triggers the blend plate actuator 126 to transition the blend plate 120 to the closed position during a first transition period, as shown in FIG. 6B. Once the blend plate 120 enters the closed position with the upper seat 124 beginning to the engage the lip 152 of the cup, the blending module 100 implements closed-loop controls to maintain a torque—applied by the blend plate actuator 126 on the blend plate axle 128—at approximately a static clamping torque, which corresponds to a target or minimum clamping force across the lip 152 of the cup to seal the cup to the blend plate 120 and thus prevent liquid from leaking out of the cup when the cup is inverted during the first transition period of the blend cycle.

As the blend plate actuator 126 thus maintains this static clamping torque on the blend plate axle 128 during the first transition period, the blending module 100 triggers the cup plate actuator 116 to transition the cup plate 110 to the blend position. In particular, the blending module 100 can activate the cup plate actuator 116 to apply a torque—opposite and greater than the static clamping torque applied by the blend plate actuator 126—to the cup plate axle 118, thereby driving the cup plate 110 and the blend plate 120 toward the blend position while preserving a seal between the cup and the blend plate 120. For example, upon locating the upper seat 124 in the blend plate 120 against the lip 152 of the cup, the blending module 100 can, during a first transition period: drive the blend plate 120 against the cup plate 110 to seal the lower seat 114 of the cup plate 110 and the upper seat 124 of the blend plate 120 against the lip 152 of the cup; and drive the cup plate 110, about the pivot axis 180, toward the blend position. More specifically, in this example, the blending module 100 can drive the blend plate 120 against the cup plate no by activating the blend plate actuator 126 coupled to the blend plate 120 to apply a static clamping force to the blend plate 120 to seal the lower seat 114 of the cup plate 110 and the upper seat 124 of the blend plate 120 against the lip 152 of the cup. Simultaneously, the blending module 100 can drive the cup plate 110, about the pivot axis 180, toward the blend position, by activating the cup plate actuator 116 coupled to the cup plate 110 to apply a torque to the cup plate 110 to drive the cup plate 110 toward the blend position, the torque applied by the cup plate 110 opposite and greater than the first static clamping force applied by the blend plate 120.

The blending module 100 can: track the position of the cup plate 110 (e.g., via the cup plate position sensor); and then disable the blend plate actuator 126 and transition to implementing closed-loop controls to maintain the output of the cup plate actuator 116 at the static clamping torque once the cup plate 110 and the blend plate 120 enter the blend position and once the blend plate 120 engages the blend plate stop at an end of the first transition period. The blending module 100 can therefore servo the output of the cup plate actuator 116 to the angular position of the cup plate no and servo the output of the blend plate actuator 126 to the torque applied to the blend plate 120 when transition the cup plate 110 and the blend plate 120 into the blend position.

The blending module 100 can also trigger the cup plate actuator 116 to apply a dynamic clamping torque on the cup plate axle 118 in the blend position during a blend period succeeding the first transition period, wherein the dynamic clamping torque is greater than the static clamping torque and yields a clamping force across the lip 152 of the cup sufficient to seal the cup to the blend plate 120 and prevent liquid from leaking out of the cup when the blender blade 122 is actuated by the blender actuator 140 to blend contents of the cup. Concurrently, the blending module 100 can actuate the blender actuator 140, such as: for a predefined duration (e.g., 15 seconds); or for a minimum duration (e.g., 10 seconds) and until the earlier of expiration of a maximum blend time (e.g., 20 seconds) or a current draw or torque output of the blender actuator 140 dropping below a threshold value corresponding to a particular viscosity or target viscosity range for smoothies. For example, as shown in FIG. 6C, the blending module 100 can, during the blend period succeeding the first transition period: trigger the cup plate actuator 116 to apply a dynamic clamping force to the cup plate 110 to compress the lip 152 of the cup against the upper seat 124 of the blend plate 120, the dynamic clamping torque exceeding the static clamping torque applied by the blend plate actuator 126 during the first transition period; and activate the blender actuator 140 coupled to the blender blade 122 and configured to rotate the blender blade 122 to blend food products in the cup into an emulsion.

The blending module 100 can also: pulse the blender actuator 140; and pulse the cup plate actuator 116 to intermittently increase the torque applied to the cup plate axle 118 and thereby increase the clamping force across the lid of the cup concurrently with actuation of the blender actuator 140, thereby reducing power consumption by the cup plate actuator 116 and reducing a period of time per blend cycle that the cup plate actuator 116 is held in a high(er)-current stall condition while also preventing leakage from the inverted cup.

In one variation, the blending module 100 can calculate a blend program for a particular cup based on food products contained in the cup. In this variation, the blending module 100 can: identify a set of food products contained in a cup; calculate a blend program based on the set of food products; and execute the blend program accordingly. The blending module 100 can calculate blend programs specifying: duration of actuating the blender actuator 140; rotational speed of the blender blade 122; frequency of pulsing of the blender actuator 140; viscosity of final product, etc. For example, the blending module 100 can: receive a first cup; identify a first set of food products contained in the cup, the first set of food products including a volume of milk, a quantity of banana, and a quantity of avocado; and calculate a first blend program based on the first set of food products. Then, at a later time, the blender module 100 can: receive a second cup; identify a second set of food products contained in the cup, the second set of food products including a volume of orange juice, a quantity of blueberries, and a quantity of spinach; and calculate a second blend program based on the second set of food products. In this example, the blending module 100 can calculate the first blend program specifying a first duration and the second blend program specifying a second duration less than the first duration based on viscosities of the first set of food products and the second set of food products. Additionally and/or alternatively, the blending module 100 can calculate the first blend program specifying a constant rotational speed of the blending blade throughout the first duration and calculate the second blend program specifying a varying rotational speed of the blending blade achieved by pulsing the blender actuator 140. Therefore, in this variation, the blending module 100 can identify ingredients contained in the cup and access characteristics (e.g., viscosity, weight, size) of these ingredients in order to calculate appropriate blend programs for each combination of ingredients.

In this variation, the blending module 100 can identify contents of the cup in order to calculate a corresponding blend program. For example, upon receiving a cup, the blending module 100 can access an order entered by a patron and associated with the cup to identify a set of ingredients contained in the cup. In another example, the blending module 100 can identify the set of ingredients contained in the cup based on a weight of the cup containing the set of ingredients. In this example, the blending module 100 can access the weight of the cup containing the set of ingredients and access an order specification list specifying weights of each food order available to patrons. Then, in response to a particular weight of a particular food order matching the weight of the cup containing the set of ingredients, the blending module 100 can identify the set of ingredients as corresponding to the particular food order.

Once the contents of the cup are thus blended, the blending module 100 can return the cup to the upright position during a second transition period, as shown in FIG. 6D, by: implementing closed-loop controls to maintain a torque—applied by the cup plate actuator 116 on the cup plate axle 118—at approximately (e.g., within ten percent) the static clamping torque; while triggering the blend plate actuator 126 to transition the blend plate 120 to the closed position. In particular, the blending module 100 can activate the cup plate actuator 116 to apply a torque—opposite and greater than the static clamping torque applied by the cup plate actuator 116—to the blend plate axle 128, thereby driving the cup plate 110 and the blend plate 120 toward the upright/closed position while preserving a seal between the cup and the blend plate 120. For example, upon conclusion of the blend period, the blending module 100 can, during the second transition cycle: drive the cup plate 110 against the blend plate 120 to seal the lower seat 114 of the cup plate 110 and the upper seat 124 of the blend plate 120 against the lip 152 of the cup; and drive the blend plate 120, about the pivot axis 180, toward the closed position. More specifically, in this example, the blending module 100 can drive the cup plate 110 against the blend plate 120 by activating the cup plate actuator 116 to apply a static clamping force to the cup plate 110 to seal the lower seat 114 of the cup plate 110 and the upper seat 124 of the blend plate 120 against the lip 152 of the cup. Simultaneously, the blending module 100 can drive the blend plate 120, about the pivot axis 180, toward the closed position, by activating the blend plate actuator 126 to apply a torque to the blend plate 120 to drive the blend plate 120 toward the closed position, the torque applied by the blend plate actuator 126 opposite and exceeding the static clamping force applied by the cup plate actuator. The blending module 100 can: track the position of the blend plate 120 (e.g., via a blend plate 120 position sensor); and then disable the cup and blend plate actuators once the cup plate 110 and the blend plate 120 enter the upright/closed position and once the cup plate 110 engages the cup plate 110 stop. The blending module 100 can therefore servo the output of the cup plate actuator 116 to the angular position of the cup plate 110 and servo the output of the blend plate actuator 126 to the torque applied to the blend plate 120 when transitioning the cup plate 110 and the blend plate 120 into the blend position.

Finally, as shown in FIG. 6E, the blending module 100 can: trigger the blend plate actuator 126 to return the blend plate 120 to the blend position to release the cup from the upper seat 124; and trigger the cup elevator 130 to transition into the extended position to raise the cup out of the cup bore 112. A transfer subsystem 190 can then retrieve the cup from the cup platform 132 to complete the blend cycle. The blending module 100 can then execute a cleaning cycle, as described below.

In one variation, the blending module 100 includes a cup position sensor (e.g., an optical depth sensor) configured to output a signal corresponding to presence of the cup on the cup platform 132. In this variation, the blending module 100 can monitor the position of the cup on the cup platform 132 to detect whether the transfer subsystem 190 removed the cup from the cup platform 132 at the end of a blend cycle. For example, the blending module 100 can, at the end of a blend cycle: raise the cup platform 132 to the extended position to deliver the cup to the transfer subsystem 190; and trigger the transfer subsystem 190 to retrieve the cup from the cup platform 132 (e.g., for delivery to a patron). Then, in response to detecting a signal output by the cup position sensor and corresponding to presence of the cup on the cup platform 132, the blending module 100 can: maintain the cup platform 132 in the extended position; trigger the transfer subsystem 190 to retrieve the cup from the cup platform 132; and repeat this process until the cup is removed from the cup platform 132 by the transfer subsystem 190. Thus, in this variation, the blending module 100 can monitor presence of the cup on the cup platform 132 during retrieval of the cup by the transfer subsystem 190 in order to detect errors during this transfer of the cup prior to executing a cleaning cycle and/or a next blend cycle.

### 10.1 Blending Variation

In one variation, the blending module 100 actuates the blender actuator 140 when the cup plate no and the blend plate 120 are between the upright/closed position and the blend position.

In one implementation, the blending module 100 triggers the cup plate actuator 116 to drive the cup plate 110 and the blend plate 120 to a partial-inversion position (e.g., with the cup plate no at 135° from the upright position and the blend plate 120 at 45° from the blend position). Once in the partial-inversion position, the cup and blend plate actuator 126 applied equal and opposite torques to the cup plate 110 and the blend plate 120 in order to maintain a minimum clamping forward access the lid of the cup. The blending module 100 then activates the blender actuator 140 to blend contents of the cup at this partial-inversion position. In this implementation, the blending module 100 can repeat this process at other partial-inversion positions in order to better ensure that food solids in the cup come into contact with the blender blade 122 and are thus blended during a blend cycle.

For example, the blending module 100 can execute this process over a sequence of angular positions between the upright/closed position and the blend position. In this example, the blending module 100 can: locate the cup at 180° from upright (i.e., the blend position) and actuate the blender actuator 140 for ten seconds or until the current draw of the blender motor drops below a first threshold corresponding to a first viscosity of contents in the cup; locate the cup at 15° from the blend position and actuate the blender actuator 140 for five seconds or until the current draw of the blender motor drops below a second, lower threshold; locate the cup at 30° from the blend position and actuate the blender actuator 140 for five seconds; locate the cup at 45° from the blend position and actuate the blender actuator 140 for five seconds or until the current draw of the blender motor drops below a final threshold corresponding to a final target viscosity of a smoothie emulsion to finalize the blending process for the cup; and then locate the cup fully upright (e.g., 180° from the blend position) and actuate the blender actuator 140 for five seconds to clear food particles from the blender blade 122.

In the foregoing example, the blending module 100 can also: actuate the blender actuator 140 continuously while driving the cup and blend plate actuators from the blend position toward the upright/closed position and maintaining at least the dynamic clamping torque between the cup plate no and the blend plate 120; and adjust the torque output of the blend plate actuator 126—and therefore the rotational speed of the cup-blend plate 120 assembly—as a function of current draw or torque output of the blender actuator 140 (and therefore as a function of viscosity of the emulsion inside the cup).

### 10.2 Leak Detection

In another variation, the blending module 100 can also detect a cup failure (e.g., rupture) or a seal failure (i.e., at the interface between the lid of the cup and the upper seal of the blend plate 120), such as: if a current draw of the blender actuator 140 drops below a minimum current draw; or if a speed of the blender actuator 140 exceeds a maximum speed during the blend cycle. Then, responsive to detecting a cup failure or a seal failure, the blending module 100 can: cancel the blend cycle; return the cup to the upright position; return the blend plate 120 to the blend position in order to release the cup; trigger the cup elevator 130 to raise and discard the cup; initiate a cleaning cycle, as described below; and queue a replacement cup—with the same contents as designated for the discarded cup—for delivery to the blending module 100 for processing.

### 10.3 Internal Cup Pressure

In one variation, the blending module 100 can also detect pressure error within the cup that can lead to deformation of the cup, such as deflation of the cup when actuating the blender blade 122 at slower speeds during the blend period and/or inflation of the cup when actuating the blender blade 122 at higher speeds during the blend period. For example, during the blend period, the blending module 100 can: access a pressure value corresponding to pressure within the cup; and, in response to the pressure value exceeding a maximum pressure threshold, detect a pressure error within the cup. Then, responsive to detecting a pressure error, the blending module 100 can reduce a speed of the blender blade 122 to reduce pressure within the cup. Similarly, the blending module 100 can increase the speed of the blender blade 122 if the pressure in the cup falls below a minimum pressure threshold. Additionally, the blending module 100 can detect whether the lip 152 of the cup is fully sealed to the blend plate 120 and the cup plate 110 during the first transition period, the blend period, and the second transition period based on the internal pressure within the cup.

### 10.4 Blend Plate Temperature

In one variation, the blending module 100 also: monitors a temperature of the blend plate 120 (or blender actuator), such as via a temperature sensor coupled to the blend plate 120 (or to the blender actuator); and implements controls to maintain the temperature of the blend plate 120 below a threshold temperature. For example, if the temperature of the blend plate 120 (or the blender actuator) exceeds a threshold temperature, the blending module 100 can: actuate a coolant pump, as described above, to pump coolant through the driveshaft, around the blender actuator, and/or through the blend plate 120; and delay execution of a next blend cycle for a next cup until the temperature of the blend plate 120 (or blender actuator) drops below the threshold temperature. In a similar example, upon lifting the cup platform 132 to receive a cup, the blending module 100 can: read a temperature of the blender blade 122 from the temperature sensor; and, in response to this temperature exceeding a threshold temperature, activate the coolant pump to pump coolant through the blend plate 120. Once the temperature of the blend plate 120 drops below the threshold temperature, the blending module 100 can trigger the cup elevator to lower this cup into the cup bore.

### 11. Cleaning

In one variation, as shown in FIG. 7, the cup elevator 130 further includes: a set of nozzles 134 arranged on the cup platform 132 and facing upwardly (i.e., toward the blender blade 122 when the blend plate 120 is occupying the closed position) and/or laterally (e.g., toward the upper and lower cup seats when the blend plate 120 occupies the closed position); and a manifold 136 that fluidly couples the set of nozzles 134 to a cleaning fluid inlet.

In this variation, the blending module 100 also includes a cleaning fluid supply 160 fluidly coupled to the manifold 136. In one example, the cleaning fluid supply 160 includes: a reservoir or accumulator, such as preloaded with cleaning solution; and a pump fluidly coupled to the manifold 136, such as via a flexible hose line. When actuated, the pump displaces cleaning solution from the reservoir, into the manifold 136, and thus through the set of nozzles 134 on the cup platform 132. In this example, the cleaning fluid supply 160 can also include a heating element, such as an inline heating element configured to heat cleaning solution between the reservoir and the cup platform 132 and/or a heating element configured to heat contents of the reservoir. In another example, the cleaning fluid supply 160 includes: a water supply connection configured to couple the pump to an external water tap; and a cleaning solution doser configured to inject soap or other cleaning solution into a fluid circuit between the water supply connection and the cup platform 132. In yet another example, the cleaning fluid supply 160 includes: a steam generator fluidly coupled to the manifold 136, such as via a flexible hose line; and a valve interposed between the steam generator and the cup platform 132 and that, when actuated, enables steam to pass from the steam generator into the manifold 136 and out of the set of nozzles 134.

In this variation, the blending module 100 can also include a basin 170 extending below the cup elevator 130, the cup plate 110, and the blend plate 120 and configured to catch cleaning fluid, food remnants, and/or other waste. The basin 170 can also include a drain, such as coupled to a bilge pump configured to actively pump contents of the basin 170 into a separate receptacle or into an external drain (e.g., a public sewer).

As described above, the cup platform 132 can be inset from the internal wall of the cup bore 112 in the cup plate 110. Therefore, cleaning solution and other waste washed from the cup plate 110 and the blend plate 120 can fall between the cup platform 132 and the internal wall of the cup bore 112 and down into the basin 170.

Alternatively, the cup platform 132 can be sized for a running fit inside the cup bore 112 such that the cup platform 132—in the extended position—forms a loose seal with the cup bore 112. Thus, when the cleaning fluid supply 160 is actuated to release cleaning fluid (e.g., water, cleaning solution, steam) through the set of nozzles 134 in the cup platform 132 during a cleaning cycle, cleaning fluid can collect in a closed volume—around the blender blade 122—formed by the cup platform 132, the cup plate 110, and the blend plate 120. The blending module 100 can then activate the blender actuator 140 to rotate the blender blade 122—now substantially immersed in clearing fluid—to clean the blade. (Excess fluid in this closed volume can also leak past the loose seal between the cup platform 132 and the internal wall of the cup bore 112.) The blending module 100 can then trigger the cup elevator 130 to retract the cup platform 132 to release the cleaning fluid from this closed volume down into the basin 170. By therefore bathing or immersing the blade in the cleaning fluid, the blending module 100 can limit total volume of cleaning solution consumed during each cleaning cycle.

Similarly, the cup platform 132 can include a flange configured to mate (or seal) against the back side of the cup plate 110 when the cup elevator 130 occupies the extended position. Thus, when the blend plate 120 occupies the closed position over the cup plate 110 with the cup elevator 130 in the extended position, the flange can close the cup bore 112 to enable cleaning fluid to collect in this closed volume and thus immerse the blade in cleaning fluid.

Yet alternatively, in the foregoing implementation, the flange can be perforated (or the cup platform 132 can include a column of similar flanges under or facing the cup bore 112 in the cup plate no) to act as a baffle for cleaning fluid flowing from around the blade down toward the basin 170 and thus reduce splashing and spray of cleaning fluid during a cleaning cycle.

### 11.1 Cleaning Cycle

Once the cup actuator raises a cup and once the cup is removed from the cup platform 132 upon conclusion of a blend cycle, the blending module 100 can execute a cleaning cycle. In one variation, as shown in FIG. 7, in response to delivering the cup after a blend cycle, the blending module 100 can execute a cleaning cycle including: rotating the blend plate 120 about the pivot axis 180 from the blend position to the closed position; dispensing a cleaning fluid through the set of nozzles 134 in the cup elevator 130 to rinse the blender blade 122 and the blend plate 120; and rotating the blend plate 120 about the pivot axis 180 from the closed position to the blend position. For example, the blending module 100 can: trigger the cup elevator 130 to retract to a cleaning position between the extended and retracted positions (e.g., such that the cup platform 132 is approximately in the plane of the lower seat 114) trigger the blend plate actuator 126 to transition the blend plate 120 back to the closed position; and then trigger the cleaning fluid supply 160 to displace cleaning fluid (e.g., water, cleaning solution, steam) into the cup platform 132 and thus through the set of nozzles 134 and toward the blender blade 122, upper cup seat, and/or lower cup seal, thereby rinsing food and other waste from these surfaces. In this example, the blending module 100 can also: actuate the blender actuator 140 in order to rotate the blade, increase exposure of the blade to the cleaning fluid, and throw waste off of the blade. The blending module 100 can actuate the blender actuator 140 at a lower speed (e.g., 10%, 30%, 50%) during a cleaning cycle than during a blend cycle in order to conserve power. The blending module 100 can also trigger the bilge pump to evacuate fluid from the basin 170 into a separate receptacle or into an external drain, such as during or upon conclusion of the cleaning cycle.

In one variation, the blending module 100 can initiate a timer to track a duration of the cleaning cycle. For example, the blending module 100 can: activate a cleaning subsystem to pump cleaning fluid through the set of nozzles 134 on the cup platform 132; initiate a timer for the cleaning cycle; dispense cleaning fluid through the set of nozzles 134; activate the blender actuator 140 to rotate the blender blade 122; and, in response to expiration of the timer, deactivate the cleaning subsystem.

In one variation, the blending module 100 adjusts the volume and/or temperature of cleaning fluid displaced through the set of nozzles 134 to clean the cup plate no and the blend plate 120 and/or adjusts a duration of this cleaning cycle based on ingredients in the last cup processed in the blender module. For example, the blending module 100 can execute a longer cleaning cycle with a greater volume of cleaning fluid consumed and at higher temperature if the last cup contained higher fat or oil content (e.g., chocolate, peanut butter) that is more prone to aggregate on the blender blade 122 and nearby surfaces. In another example, the blending module 100 can heat the cleaning fluid to a higher temperature in order to sanitize the blender blade 122 and nearby surfaces if the last cup processed by the blending module 100 included a dairy product. Otherwise, by default, the blending module 100 can execute a cleaning cycle with a lesser volume of cleaning fluid and at lower temperature over a shorter duration.

In one variation, the blending module 100 can activate the blend plate actuator 126 to tilt the blender blade 122 during a cleaning cycle to increase cleaning efficiency. For example, the blending module 100 can: activate a cleaning subsystem to pump cleaning fluid through the set of nozzles 134; dispense cleaning fluid through the set of nozzles 134; activate the blender actuator 140 to activate the blender blade 122; activate the blend plate actuator 126 to tilt the blend plate 120 upward at an acute angle (e.g., twenty degrees) from the set of nozzles 134; and, in response to a duration of the cleaning cycle exceeding a threshold duration, deactivate the cleaning subsystem. In another example, the blending module 100 can tilt the blender blade 122 up to an acute angle over a set duration to increase rinsing efficiency of the blender blade 122 and the blend plate 120. For example, the blending module 100 can: activate a cleaning subsystem to pump cleaning fluid through the set of nozzles 134; dispense cleaning fluid through the set of nozzles 134; activate the blender actuator 140 to rotate the blender blade 122; tilt the blender blade 122 upward toward a twenty-degree angle at a set rate (e.g., one degree per second); and, in response to reaching the twenty-degree angle, deactivate the cleaning subsystem. Therefore, by tilting the blender blade 122 across a range of angles, the blending module 100 can increase rinsing efficiency of the blender blade 122 and the blend plate 120.

### 11.2 Top-Down Cleaning Cycle

In this variation, the blending module 10o can also include a set of overhead nozzles arranged over and facing downward toward the cup blade and/or blend plate 120 and fluidly coupled to the cleaning fluid supply 160. Thus, during a cleaning cycle, the blending module 100 can additionally or alternatively: trigger the cup and blend plate actuators to drive the cup plate 110 to the upright position and the blend plate 120 to the blend position; and trigger the cleaning fluid supply 160 to displace cleaning fluid into the overhead nozzles in order to wash down the cup plate 110 and the blend plate 120. For example, after executing the foregoing process to wash the cup plate 110 and the blend plate 120 via cleaning fluid dispensed through the set of nozzles 134 on the cup platform 132, the blending module 100 can execute this secondary rinse cycle to rinse the cup plate 110 and blend plate 120 of any further residue before initiating a next blend cycle.

### 11.3 Cleaning Cycle Triggers

In this variation, the blending module 10o can execute a cleaning cycle: upon conclusion of every blend cycle; upon conclusion of a sequence of (e.g., five) blend cycles; or if more than a threshold duration of time has passed since a last blend cycle or cleaning cycle was completed by the blending module 100. In another example, the blending module 100 can execute a cleaning cycle between processing two cups containing contents with conflicting flavors (e.g., chocolate and then lemon). However, the blending module 100 can execute a cleaning cycle responsive to any other event or trigger.

### 11.4 Sanitizing Cycle

In one variation, the blending module 100 can execute a sanitizing cycle to sanitize surfaces that contact food products and/or food waste. The blending module 100 can execute the sanitizing cycle: if more than a threshold duration of time has passed since a last sanitizing cycle; or upon conclusion of a sequence of (e.g., ten) blend cycles.

In one variation, the blending module 100 can execute a sanitizing cycle including executing a blend cycle for a cup containing sanitizing fluid. When the blend cycle is completed, the blending module 100 can discard the cup or store the cup for reuse in future sanitizing cycles.

For example, similar to the blend and cleaning cycles, the blending module 100 can: raise the cup platform 132 to the extended position to receive a cup containing sanitizing fluid; lower the cup platform 132 to the retracted position to locate a lip 152 of the cup on the lower seat 114 of the cup plate 110; and rotate the blend plate 120 about the pivot axis 180 from the blend position to the closed position to locate the upper seat 124 of the blend plate 120 against the lip 152 of the cup. Then, during a first rotation period of the sanitizing cycle, the blending module 100 can: drive the blend plate 120 against the cup plate 110 to seal the lower seat 114 of the cup plate 110 and the upper seat 124 of the blend plate 120 against the lip 152 of the cup; and drive the cup plate 110, about the pivot axis 180, toward the blend position. Alternatively, the blending module 100 can enable contents of the cup (e.g., sanitizing fluid) to leak from the cup by driving the blend plate 120 against the cup plate no at a force less than a minimum force required to seal the lower seat 114 of the cup plate 110 and the upper seat 124 of the blend plate 120 against the lip 152 of the cup. By enabling contents of the cup to leak from the cup, the blending module 100 can sanitize surfaces surrounding the cup plate 110 and blend plate 120 that can contact food products during blend cycles. Then, during a sanitizing period succeeding the first rotation period, the blending module 100 can activate the blender blade 122 to sanitize surfaces of the blender blade 122. During the sanitizing period, the blending module 100 can enable contents of the cup to leak onto surfaces surrounding and below the cup by maintaining a loose seal between the lower seat 114 of the cup plate 110 and the upper seat 124 of the blend plate 120 against the lip 152 of the cup. Then, during a second rotation period succeeding the sanitizing period, the blending module 100 can rotate the blend plate 120 about the pivot axis 180 toward the blend position, and raise the cup platform 132 from the retracted position to the extended position to lift the cup out of the cup bore 112 and to dispose of the cup. In one implementation, the blending module 100 can receive a cup containing sanitizing fluid and defining a set of orifices such that sanitizing fluid flows from an interior of the cup, through the set of orifices, and contacts surfaces of the blending module 100 external the cup.

In another example, the blending module 100 can execute a sanitizing cycle by dispensing sanitizer fluid through the set of nozzles 134 of the cup elevator 130, as described above for a cleaning cycle. In this example, the blending module 100 can execute a sanitizing cycle including: rotating the blend plate 120 about the pivot axis 180 from the blend position to the closed position; raising the cup elevator 130 such that the cup platform 132 sits offset below (e.g., five millimeters) the blender blade 122 of the blend plate 120; activating a pump to dispense a sanitizer fluid through the set of nozzles 134 on the cup platform 132 of the cup plate 110 to sanitize surfaces of the blender blade 122, the blend plate 120, the cup plate 110 (e.g., from sanitizer fluid splashing off the cup plate 110 and/or dripping down), and other surfaces surrounding the cup plate 110 and the cup elevator 13o; deactivating the pump; and returning the blend plate 120 to the blend position and lowering the cup elevator 130 to the retracted position.

### 12. Multiple Blending Modules

In one implementation, the blending module 100 is incorporated in a set of blending modules. In this implementation, each blending module 100 in the set of blending modules can execute blend and cleaning cycles, each blending module 100 in the set of blending modules configured to blend food products into a final food product (e.g., a smoothie).

In one variation, the set of blending modules can be installed in a linear configuration. For example, a set of five blending modules 100 can be installed in a linear row. In another variation, the set of blending modules can be installed in a rotary configuration. In the rotary configuration, each blending module 100 can rotate positions about a circumference of the rotary formation, such that each blending module 100 receives and delivers cups to and from a first transfer subsystem (e.g., robotic arm) in a first position on the circumference. Alternatively, each blending module 100 can receive cups from a first transfer subsystem (e.g., robotic arm) in a first position on the circumference and deliver cups to a second transfer subsystem in a second position on the circumference. The set of blending modules 100 can cooperate to decrease down time between blend cycles (e.g., during cleaning cycles) and increase overall rates of food processing (e.g., blending) by processing multiple cups at a time.

As a person skilled in the art will recognize from the previous detailed description and from the figures and claims, modifications and changes can be made to the embodiments of the invention without departing from the scope of this invention as defined in the following claims.

I claim:

1. A method for blending food products comprises, during a blend cycle:
raising a cup platform from a retracted position, through a cup bore in a cup plate occupying an upright position, to an extended position above the cup plate to receive a cup containing food products;
lowering the cup platform from the extended position, through the cup bore, to the retracted position to locate a lip of the cup on a lower seat of the cup plate, the cup bore longitudinally offset from the pivot axis and encircled by the lower seat;
rotating a blend plate about the pivot axis from a blend position to a closed position to locate an upper seat in the blend plate against the lip of the cup, the blend plate comprising a blender blade, the blender blade encircled by the upper seat and facing the cup bore when the blend plate and the cup plate occupy the blend position;
during a first transition period:
driving the cup plate, about the pivot axis, toward the blend position; and
driving the blend plate against the cup plate to seal the lower seat of the cup plate and the upper seat of the blend plate against the lip of the cup; and
during a blend period succeeding the first transition period, activating the blender blade to blend food products in the cup to form an emulsion;
during a second transition period succeeding the blend period:
driving the blend plate, about the pivot axis, toward the closed position; and
driving the cup plate against the blend plate to seal the lower seat of the cup plate and the upper seat of the blend plate against lip of the cup; and
following the second transition period, rotating the blend plate about the pivot axis toward the blend position; and
raising the cup platform from the retracted position to the extended position to lift the cup out of the cup bore and to deliver the cup.

2. The method of claim 1, further comprising, during a cleaning cycle succeeding the blend cycle:
lowering the cup platform from the extended position toward the retracted position;
rotating the blend plate about the pivot axis from the blend position toward the closed position to locate the blender blade of the blend plate offset above the cup platform;
during a cleaning period:
dispensing cleaning fluid through a set of nozzles in the cup platform and facing the blender blade; and
activating the blender blade to rinse surfaces of the blender blade with cleaning fluid; and
rotating the blend plate, about the pivot axis, from the closed position toward the blend position.

3. The method of claim 2:
wherein dispensing cleaning fluid through the set of nozzles comprises activating a cleaning subsystem to pump cleaning fluid from a reservoir, to the cup platform, and through the set of nozzles; and
wherein activating the blender blade, during the cleaning period, further comprises tilting the blend plate upward at an acute angle away from the set of nozzles to spray surfaces of the blender blade.

4. The method of claim 3:
wherein dispensing cleaning fluid through the set of nozzles further comprises activating a heating element to heat cleaning solution between the reservoir and the cup platform; and
wherein dispensing cleaning fluid comprises dispensing steam.

5. The method of claim 1:
wherein raising the cup platform to receive the cup comprises raising the cup platform to receive the cup loaded with food products by a set of food dispensers during a food dispensation cycle preceding the blend cycle; and
wherein raising the cup platform to deliver the cup comprises raising the cup platform to deliver the cup to a patron associated with a food order corresponding to the cup.

6. The method of claim 1, further comprising:
prior to the blend period:
identifying a set of food products contained in the cup; and
calculating a blend program based on the set of food products; and
during the blend period, executing the blend program.

7. The method of claim 6:
wherein calculating the blend program comprises:
in response to identifying a first set of ingredients comprising a volume of milk, a quantity of banana, and a quantity of avocado, calculating a first blend program; and
in response to identifying. a second set of ingredients comprising a volume of orange juice, a quantity of blueberries, and a quantity of spinach, calculating a second blend program; and
wherein calculating the first blend program comprises calculating the first blend program of a first duration based on a first viscosity of the first set of ingredients; and
wherein calculating the second blend program comprises calculating the second blend program of a second duration based on a second viscosity of the second set of ingredients, the second viscosity less than the first viscosity, the second duration less than the first duration.

8. The method of claim 1, further comprising, during the blend cycle preceding the first transition cycle:
accessing a temperature of the blend plate; and
in response to the temperature exceeding a threshold temperature, pumping a volume of coolant through the blend plate, the volume of coolant proportional to the temperature.

9. The method of claim 1, wherein:
during the first transition period:
driving the cup plate, about the pivot axis, toward the blend position, comprises activating a cup plate actuator to apply a first torque to the cup plate to drive the cup plate toward the blend position; and
driving the blend plate against the cup plate comprises activating a blend plate actuator coupled to the blend plate to apply a first static clamping torque to the blend plate to seal the lower seat of the cup plate and the upper seat of the blend plate against the lip of the cup, the first static clamping torque less than the first torque and opposite the first torque; and
during the second transition period:
driving the blend plate, about the pivot axis, toward the closed position comprises activating the blend plate actuator to apply a second torque to the blend plate to drive the blend plate toward the closed position; and
driving the cup plate against the blend plate comprises activating the cup plate actuator to apply a second static clamping torque to the cup plate to seal the lower seat of the cup plate and the upper seat of the blend plate against the lip of the cup, the second static clamping torque less than the second torque and opposite the second torque.

10. The method of claim 9:
wherein rotating the blend plate about the pivot axis from the blend position to the closed position comprises activating the blend plate actuator to drive the blend plate about the pivot axis from the blend position to the closed position;
wherein activating the blender blade comprises activating a blender actuator coupled to the blender blade and configured to rotate the blender blade; and
further comprising, during the blend period, triggering the cup plate actuator to apply a dynamic clamping torque to the cup plate to compress the lip of the cup against the upper seat of the blend plate, the dynamic clamping torque exceeding the first static clamping torque and the second static clamping torque.

11. The method of claim 1, further comprising, during a sanitizing cycle succeeding the blend cycle:
raising the cup platform to the extended position to receive a sanitizing cup containing sanitizing fluid;
lowering the cup platform to the retracted position to locate a lip of the sanitizing cup on the lower seat of the cup plate;
rotating the blend plate about the pivot axis from the blend position to the closed position to locate the upper seat of the blend plate against the lip of the sanitizing cup;
during a first rotation period:
driving the cup plate, about the pivot axis, toward the blend position; and
driving the blend plate against the cup plate to seal the lower seat of the cup plate and the upper seat of the blend plate against lip of the cup; and
during a sanitizing period succeeding the first rotation period, activating the blender blade to sanitize surfaces of the blender blade;
during a second rotation period succeeding the sanitizing period:
driving the cup plate against the blend plate to seal the lower seat of the cup plate and the upper seat of the blend plate against lip of the cup; and
driving the blend plate, about the pivot axis, toward the closed position; and
following the second rotation period, rotating the blend plate about the pivot axis toward the blend position; and
raising the cup platform from the retracted position to the extended position to lift the cup out of the cup bore and to dispose of the cup.

12. A system for blending food products comprises:
a cup plate:
configured to pivot about a pivot axis between an upright position and a blend position;
defining a cup bore offset from the pivot axis and configured to receive a cup containing food products; and
defining a lower seat around the cup bore and configured to support a lip of the cup; and
a blend plate:
configured to pivot about the pivot axis between a closed position and the blend position;
comprising a blender blade facing the cup bore when the blend plate and the cup plate occupy the blend position; and
defining an upper seat around the blender blade; and
a cup elevator:
approximately concentric with the cup bore when the cup plate occupies the upright position;
extending through the cup bore to receive the cup in an extended position; and
retracting below the cup bore to locate the lip of the cup on the lower seat of the cup plate in the retracted position; and
a blender actuator configured to rotate the blender blade;
a cup plate actuator configured to apply a first torque to the cup plate to drive the cup plate from the upright position to the blend position during a first transition period; and
a blend plate actuator configured to:
drive the blend plate from the blend position to the closed position in response to the cup elevator seating the lip of the cup on the lower seat of the cup plate; and
apply a static clamping torque to the blend plate against the cup plate actuator to seal the lower seat of the cup plate and the upper seat of the blend plate against the lip of the cup during the first transition period, the static clamping torque less than the first torque and opposite the first torque.

13. The system of claim 12:
configured to install at an end of a series of food dispensers and liquid dispensers in a modular food assembly kiosk, the food and liquid dispensers configured to dispense ingredients into the cup;
configured to receive the cup loaded with ingredients from the series of food and liquid dispensers; and
configured to deliver the cup to a patron.

14. The system of claim 12:
wherein the cup bore comprises a circular cup bore exhibiting a first diameter between a maximal diameter and a minimal diameter of the lip of the cup;
wherein the lower seat exhibits a second diameter greater than the first diameter; and
wherein the lower seat is configured to receive and retain an underside of the lip of the cup with a base of the cup extending below the cup plate.

15. The system of claim 12:
further comprising a transfer subsystem configured to:
load the cup into the cup elevator;
retrieve the cup from the cup elevator; and
deliver the cup to a delivery window for retrieval by a patron; and
wherein the transfer subsystem comprises a set of robotic arms.

16. The system of claim 12:
wherein the blend plate actuator is configured to drive the blend plate from the blend position to the closed position in response to the blender actuator deactivating the blender blade; and
wherein the cup plate actuator is configured to apply the static clamping torque to the cup plate against the blend plate actuator driving the blend plate toward the closed position.

17. The system of claim 12:
configured to activate the blender actuator to rotate the blender blade to blend contents of the cup in response to the cup plate occupying the blend position; and
wherein the cup plate actuator is configured to apply a dynamic clamping torque to the cup plate to compress the lip of the cup against the upper seat of the blend plate in response to the cup plate occupying the blend position, the dynamic clamping torque greater than the static clamping torque.

18. The system of claim 12:
wherein the cup elevator defines:
a cup platform configured to receive and support a base of the cup and inset from an internal wall of the cup bore;
a set of nozzles arranged on the cup platform facing the blender blade when the blend plate occupies the closed position and configured to spray the blender blade and the blend plate with cleaning fluid in the closed position during a cleaning cycle; and
a manifold configured to fluidly couple the set of nozzles to a cleaning fluid inlet; and
further comprising a basin:
extending below the cup elevator, the cup plate, and the blend plate;
configured to catch cleaning fluid and food products; and
coupled to a pump configured to pump contents of the basin into an external receptacle.

19. The system of claim 18:
further comprising a cleaning fluid supply fluidly coupled to the manifold; and
wherein the cleaning fluid supply comprises:
a reservoir configured to hold cleaning fluid; and
a pump fluidly coupled to the manifold and configured to displace cleaning fluid from the reservoir, into the manifold, and through the set of nozzles.

20. The system of claim 12:
wherein the cup elevator defines:
a linear slide defining an extensible axis approximately parallel to the cup bore when the cup plate occupies the upright position; and
a cup platform coupled to a distal end of the linear slide and configured to receive and support a base of the cup; and
wherein the cup platform:
defines a tapered bore configured to accept and center the base of the cup on the cup platform;
defines a set of vacuum ports fluidly coupled to a vacuum pump and configured to draw a vacuum across a face of the cup platform and retain the base of the cup on the cup platform until the cup engages the lower seat in the upright position; and
sits in the retracted position offset below the base of the cup in the upright position to enable the cup to seat in the cup bore.
